(19) United States
(12) Patent Application Publication
(10) Pub. No.: US 2025/0108673 A1
(43) Pub. Date: Apr. 3, 2025

(54) VEHICULAR AIR CONDITIONING SYSTEM

(71) Applicant: HANON SYSTEMS, Daejeon (KR)

(72) Inventors: Joon Yeong LEE, Daejeon (KR); Dong Gyun KIM, Daejeon (KR); Han Su KIM, Daejeon (KR); Chang Soo BAE, Daejeon (KR); Gyu Ik HAN, Daejeon (KR)

(21) Appl. No.: 18/729,916

(22) PCT Filed: Mar. 21, 2023
(86) PCT No.: PCT/KR2023/003700

§ 371 Date: Jul. 18, 2024

(30) Foreign Application Priority Data
Mar. 23, 2022 (KR) 10-2022-0036103
Mar. 17, 2023 (KR) 10-2023-0035132

(51) Int. Cl. B60H 1/00

(52) U.S. Cl. CPC B60H 1/00064; B60H 2001/00164; B60H 2001/00185

(57) ABSTRACT

A vehicular air conditioning system includes a cooling heat exchanger and a heating heat exchanger sequentially installed on an internal flow path of an air conditioning case to cool and heat an air blown from a blower, a plurality of air discharge ports configured to discharge cold air and hot air passing through the cooling heat exchanger and the heating heat exchanger into a passenger room, a first bypass flow path configured to allow the air blown from the blower to bypass to an upstream side of the heating heat exchanger before passing through the cooling heat exchanger, and a first opening/closing door configured to open and close the first bypass flow path.

### TECHNICAL FIELD

The present invention relates to a vehicular air conditioning system, and more particularly, a vehicular air conditioning system capable of improving the structure of a heating heat exchanger and the air flow structure to reduce the electricity consumption of the heating heat exchanger without reducing the comfort in a passenger room and differentiate the discharge air temperature for the upper and lower sections of the passenger room.

### BACKGROUND ART

It has been an important task to downsize and slim a vehicular air conditioning system for the efficiency of an installation space within a vehicle.

Particularly, in recent years, there has been an urgent need to downsize a vehicle and secure a space in a passenger room for the convenience of passengers. In response to this need, downsizing and slimming a vehicular air conditioning system has become an important task.

As a method of downsizing and slimming a vehicular air conditioning system, there is a method of reducing an unnecessary space by improving the internal structure of an air conditioning case.

In particular, among the various parts installed inside the air conditioning case, certain parts may be removed without limiting their functions. Thus, the space required to install specific parts can be reduced or eliminated, thereby downsizing and slimming the air conditioning system.

As an example, there is known a temperature doorless technique capable of downsizing and slimming an air conditioning system by removing a temperature door without limiting a temperature control function for air discharged into a passenger room and consequently reducing the internal space of an air conditioning case.

An example of a temperature doorless air conditioning device is disclosed in Korean Patent Application No. 2020-0057810 for “vehicular air conditioning system”.

This technique removes a temperature door that controls the temperature of air discharged into a passenger room. The temperature control function of the temperature door is performed by an electric heater, which is a heating heat exchanger.

In particular, by variably controlling the heating temperature of the electric heater, the temperature of air discharged into a passenger room can be adjusted as the hot air passing through the electric heater is mixed with the cold air passing through an evaporator, which is a cooling heat exchanger.

Thus, the temperature of the air discharged into the passenger room can be adjusted without having to use a temperature door, and as a result, the internal space of the air conditioning case can be reduced, thereby downsizing and slimming the air conditioning system.

However, this conventional air conditioning system has a structure in which the temperature in the passenger room is adjusted using only the electric heater, which leads to a disadvantage of consuming a lot of energy.

In particular, the electric heater of the air conditioning system is composed of a high-voltage PTC electric heater whose heat generation amount is controlled by controlling the duty ratio (pulse width modulation) of a PWM (Pulse Width Modulation) signal. This PTC electric heater (hereinafter referred to as a heating heat exchanger) has a disadvantage that the consumption of electricity is very large.

This leads to a problem that the fuel efficiency of a vehicle decreases. In particular, an electric vehicle has a problem that the fuel efficiency of the vehicle is significantly reduced due to the use of a heating heat exchanger. Thus, the vehicle's driving distance is significantly shortened.

In addition, the conventional air conditioning system has a structure in which the cold air passing through an evaporator (hereinafter referred to as a “cooling heat exchanger”) and the hot air passing through the heating heat exchanger are mixed altogether and discharged into the passenger room. Thus, the temperature of the air discharged into the passenger room is uniform regardless of the sections of the passenger room. Therefore, the temperature of the air discharged into the passenger room cannot be differentiated for each section of the passenger room.

In particular, a passenger in a vehicle will feel comfortable only if a cold-head/hot-leg state is maintained by discharging a relatively low-temperature air to the upper section of the passenger room on the side of the driver's head, and discharging a relatively high-temperature air to the lower section of the passenger room on the side of the driver's torso or legs.

However, if the temperature of the air discharged into the passenger room is uniform regardless of the sections of the passenger room as in the past, it is impossible to differentiate the temperature of the air discharged into the passenger room in the upper and lower sections of the passenger room. Therefore, the comfort in the passenger room is significantly reduced.

### DETAILED DESCRIPTION OF THE INVENTION

### Technical Task

In view of the problems inherent in the related art, it is an object of the present invention to provide a vehicular air conditioning system capable of improving the structure of a heating heat exchanger and the air flow structure to reduce the electricity consumption of the heating heat exchanger without deteriorating the comfort in a passenger room.

Another object of the present invention is to provide a vehicular air conditioning system capable of improving the vehicle fuel efficiency without deteriorating the comfort in a passenger room, by adopting the configuration in which the electricity consumption of the heating heat exchanger can be reduced without deteriorating the comfort in the passenger room.

A further object of the present invention is to provide a vehicular air conditioning system capable of differentiating the temperature of an air discharged toward the upper and lower sections of the passenger room by improving the structure of a heating heat exchanger and the air flow structure.

A still further object of the present invention is to provide a vehicular air conditioning system capable of maintaining a cold-head/hot-leg state and consequently improving the comfort in a passenger room by discharging a low-temperature air to the upper section of the passenger room and discharging a high-temperature air to the lower section of the passenger room.

### Means to Solve the Task

According to one embodiment of the present invention, there is provided a vehicular air conditioning system, including: a cooling heat exchanger and a heating heat exchanger sequentially installed on an internal flow path of an air conditioning case to cool and heat air blown from a blower; a plurality of air discharge ports configured to discharge cold air and hot air passing through the cooling heat exchanger and the heating heat exchanger into a passenger room; a first bypass flow path configured to allow the air blown from the blower to bypass to an upstream side of the heating heat exchanger before passing through the cooling heat exchanger; and a first opening/closing door configured to open and close the first bypass flow path.

The heating heat exchanger has a first region facing the first bypass flow path and a second region facing the cooling heat exchanger, and the first region and the second region are independently temperature-controllable regions configured to generate heat at different temperatures.

The passenger room has a section into which the air passing through the first region of the heating heat exchanger is discharged and a section into which the air passing through the second region of the heating heat exchanger is discharged, and the temperatures of the sections of the passenger room are differentiated from each other by the air passing through the first region and the second region and having different temperatures.

The first bypass flow path is arranged on the same air flow path as a floor-side air discharge port which constitutes the air discharge ports of the air conditioning case and discharges air toward a lower section of the passenger room, so that the air can be discharged toward the lower section of the passenger room after passing through the first region of the heating heat exchanger.

The first region corresponds to an air flow path extending from the first bypass flow path to the floor-side air discharge port, the second region corresponds to another air flow path, and the first region is independently temperature-controllable with respect to the second region so as to independently control the temperature of the air discharged from the first bypass flow path toward the lower section of the passenger room through the floor-side air discharge port.

The second region corresponds to an air flow path extending from the cooling heat exchanger to a roof-side air discharge port that discharges air toward an upper section of the passenger room, and the second region is independently temperature-controllable with respect to the first region so as to differentiate the temperature of the air discharged toward the lower section of the passenger room from the temperature of the air discharged toward the upper section of the passenger room.

The first region is controlled to have a higher temperature than the first region so as to make the temperature of the air discharged toward the lower section of the passenger room higher than the temperature of the air discharged toward the upper section of the passenger room.

The first opening/closing door is configured to open and close the first bypass flow path according to an air conditioning mode.

In a cooling mode, the first opening/closing door is configured to block the first bypass flow path so that the air blown from the blower is cooled while passing through the cooling heat exchanger.

In a heating mode, the first opening/closing door is configured to open the first bypass flow path so that a part of the air blown from the blower is heated while being directly introduced to the heating heat exchanger before passing through the cooling heat exchanger.

The system further includes: a second bypass flow path configured to allow a part of the air passing through the cooling heat exchanger to be directly bypassed to the air discharge ports before passing the heating heat exchanger; and a second opening/closing door configured to open and close the second bypass flow path.

The second bypass flow path is arranged on the same air flow path as a roof-side air discharge port which constitutes the air discharge ports of the air conditioning case and discharges air toward the upper section of the passenger room, so that the air on the side of the cooling heat exchanger can be directly discharged toward the upper section of the passenger room.

### Effect of the Invention

According to the vehicular air conditioning system of the present invention, the heating heat exchanger is composed of the plurality of independently temperature-controllable heating parts, and the temperature of a specific section of the passenger room can be controlled to a desired temperature only by controlling the temperature of a specific one of the heating parts. As a result, the electricity consumption of the heating heat exchanger can be reduced without deteriorating the comfort in the passenger room.

In addition, since the electricity consumption of the heating heat exchanger can be reduced without deteriorating the comfort in the passenger room, it is possible to improve the fuel efficiency and electricity efficiency of the vehicle without deteriorating the comfort in the passenger room.

In addition, since a specific one of the heating parts of the heating heat exchanger has a structure capable of independently controlling the temperature of the air discharged toward the lower section of passenger room, it is possible to differentiate the temperature of the air discharged toward the lower section of the passenger room from the temperature of the air discharged toward the upper section of the passenger room.

In addition, since the temperature of the air discharged toward the lower section of the passenger room can be differentiated from the temperature of the air discharged toward the upper section of the passenger room, it is possible to maintain a cold-head/hot-leg state and consequently improve the comfort in the passenger room by supplying a low-temperature air toward the upper section of the passenger room and supplying a high-temperature air toward the lower section of the passenger room.

### BRIEF DESCRIPTION OF THE DRAWINGS

FIG. 1 is a view showing the configuration of a vehicular air conditioning system according to the present invention.

FIG. 2 is a sectional view taken along line II-II in FIG. 1.

FIG. 3 is a view showing an operation example of the vehicular air conditioning system according to the present invention.

### BEST MODE TO IMPLEMENT THE INVENTION

A preferred embodiment of a vehicular air conditioning system according to the present invention will now be described in detail with reference to the accompanying drawings.

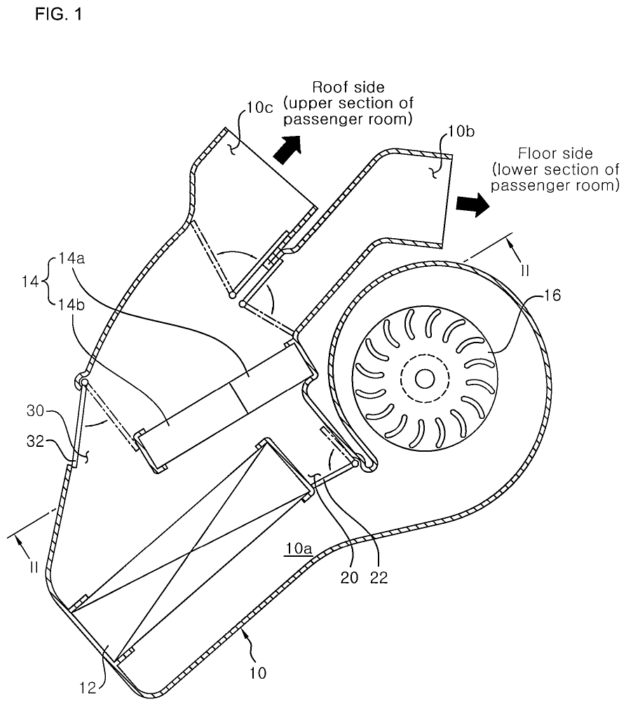

Prior to describing the features of the vehicular air conditioning system according to the present invention, a temperature doorless air conditioning system will be briefly described with reference to FIG. 1.

The temperature doorless air conditioning system has a structure in which a cooling heat exchanger 12 and a heating heat exchanger 14 are sequentially installed in an internal flow path 10a of an air conditioning case 10.

The cooling heat exchanger 12 cools the air blown along the internal flow path 10a of the air conditioning case 10 after being discharged from a blower 16.

The heating heat exchanger 14 is installed at an interval on the rear side of the cooling heat exchanger 12 to heat the cold air passing through the cooling heat exchanger 12 while generating heat using the electricity applied thereto.

In particular, the heating heat exchanger 14 heats the air that has passed through the cooling heat exchanger 12 while the heat generation amount is controlled by PWM duty ratio control. Through this heating, instead of the conventional temperature door, the heating heat exchanger 14 variably controls the temperature of the air blown into a passenger room.

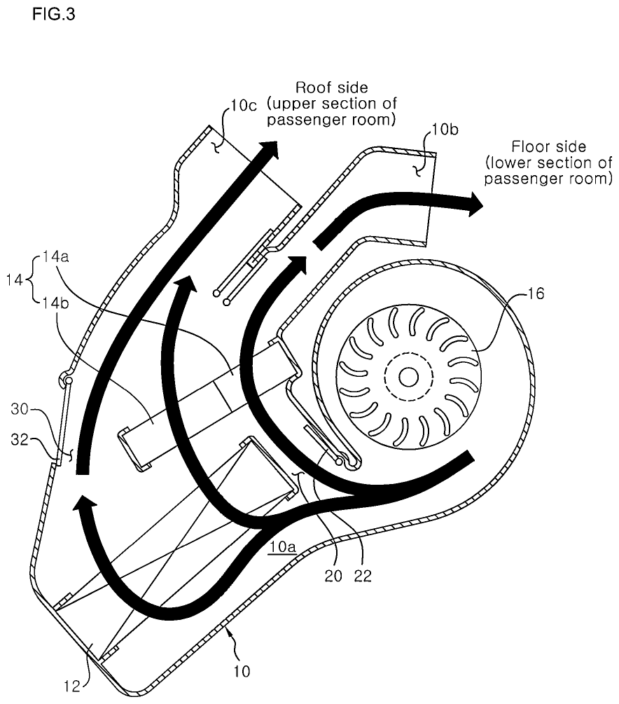

Next, the features of the vehicular air conditioning system according to the present invention will be described in detail with reference to FIGS. 1 and 3.

Referring first to FIG. 1, the air conditioning system of the present invention includes a first bypass flow path 20 configured to bring the upstream side of the cooling heat exchanger 12 and the upstream side of the heating heat exchanger 14 into communication with each other, and a first opening/closing door 22 configured to open and close the first bypass flow path 20.

The first bypass flow path 20 allows the air blown from the blower 16 before passing through the cooling heat exchanger 12 to bypass toward the upstream side of the heating heat exchanger 14.

Therefore, the air blown from the blower 16 does not pass through the cooling heat exchanger 12, but is directly introduced into the heating heat exchanger 14 and heated by the heating heat exchanger 14.

Thus, in a specific mode, for example, in a heating mode, it is possible to suppress the air blown from the blower 16 from unnecessarily passing through the cooling heat exchanger 12.

As a result, in the heating mode, it is possible to minimize the air flow resistance which may be generated when the air blown from the blower 16 passes through the cooling heat exchanger 12. Accordingly, it is possible to minimize the generation of noise and the decrease in the amount of air discharged into the passenger room, which may be caused due to the air flow resistance.

In particular, since the decrease in the amount of air discharged into the passenger room can be minimized, it is possible to relatively increase the amount of air passing through the heating heat exchanger 14 and discharged into the passenger room, thereby improving the heating performance for the passenger room.

The first opening/closing door 22 is installed on the first bypass flow path 20, and is configured to open and close the first bypass flow path 20 according to the air conditioning mode.

In particular, in a cooling mode during the summer when the temperature is high, the first bypass flow path 20 is blocked.

Therefore, the air blown from the blower 16 can be cooled while passing through the cooling heat exchanger 12. As a result, the air blown from the blower 16 is cooled through the cooling heat exchanger 12 and is discharged into the passenger room.

Additionally, the first opening/closing door 22 opens the first bypass flow path 20 in the heating mode during the winter when the temperature is low.

Therefore, in the heating mode, a part of the air blown from the blower 16 is directly introduced into the heating heat exchanger 14 before passing through the cooling heat exchanger 12, and is heated by the heating heat exchanger 14.

As a result, it is possible to suppress the air blown from the blower 16 from unnecessarily passing through the cooling heat exchanger 12. Thus, in the heating mode, it is possible to minimize the air flow resistance and the resulting decrease in the amount of air discharged into the passenger room, which may occur when the air blown from the blower 16 unnecessarily passes through the cooling heat exchanger 12.

In this regard, the first bypass flow path 20 is preferably formed at a position corresponding to the floor-side air discharge port 10b that discharges air toward the lower section of the passenger room among the air discharge ports 10b and 10c of the air conditioning case 10.

In particular, the first bypass flow path 20 is preferably formed at a position corresponding to the floor-side air discharge port 10b so that the first bypass flow path 20 and the floor-side air discharge port 10b are arranged on the same air flow path.

This is to ensure that the air on the first bypass flow path 20 side passes through the heating heat exchanger 14 and then is discharged through the floor-side air discharge port 10b, thereby allowing the high-temperature air passing through the heating heat exchanger 14 to be discharged toward the lower section of the passenger room as much as possible.

Referring again to FIG. 1, the air conditioning system of the present invention includes a second bypass flow path 30 configured to bring the downstream side of the cooling heat exchanger 12 and the air discharge ports 10b and 10c of the air conditioning case 10 into communication with each other, and a second opening/closing door 32 configured to open and close the second bypass flow path 30.

The second bypass flow path 30 directly bypasses the air that has passed through the cooling heat exchanger 12 to each of the air discharge ports 10b and 10c of the air conditioning case 10.

In particular, a part of the cold air that has passed through the cooling heat exchanger 12 is bypassed directly to each of the air discharge ports 10b and 10c without passing through the heating heat exchanger 14.

Therefore, it is possible to suppress the cold air on the side of the cooling heat exchanger 12 from unnecessarily passing through the heating heat exchanger 14. In particular, in the cooling mode, it is possible to suppress the cold air passing through the cooling heat exchanger 12 from unnecessarily passing through the heating heat exchanger 14.

As a result, in the cooling mode, it is possible to minimize the air flow resistance which may be caused when the cold air on the cooling heat exchanger 12 side unnecessarily passes through the heating heat exchanger 14. Accordingly, it is possible to minimize the generation of noise and the decrease in the amount of air discharged into the passenger room, which may be caused by the air flow resistance.

The second opening/closing door 32 is installed on the second bypass flow path 30, and is configured to open and close the second bypass flow path 30 according to the air conditioning mode.

In particular, in the cooling mode during the summer when the temperature is high, the second bypass flow path 30 is opened.

Therefore, in the cooling mode, a part of the air that has passed through the cooling heat exchanger 12 is bypassed toward the air discharge ports 10b and 10c before passing through the heating heat exchanger 14.

As a result, it is possible to suppress the air passing through the cooling heat exchanger 12 from unnecessarily passing through the heating heat exchanger 14. Thus, in the cooling mode, it is possible to minimize the air flow resistance and the resulting decrease in the amount of air discharged into the passenger room, which may occur when the air on the side of the cooling heat exchanger 12 unnecessarily passes through the heating heat exchanger 14. In the heating mode during the winter when the temperature is low, the second opening/closing door 32 may preferably block the second bypass flow path 30 in some cases.

Therefore, it is desirable to allow the air blown from the blower 16 to be heated while passing through the heating heat exchanger 14. Accordingly, it is desirable to allow the air blown from the blower 16 to be heated through the heating heat exchanger 14 and discharged into the passenger room.

In this regard, the second bypass flow path 30 is preferably formed at a position corresponding to the roof-side air discharge port 10c that discharges air toward the upper section of the passenger room among the air discharge ports 10b and 10c of the air conditioning case 10.

In particular, the second bypass flow path 30 is preferably formed at a position corresponding to the roof-side air discharge port 10c so that the second bypass flow path 30 and the roof-side air discharge port 10c are arranged on the same air flow path.

This is to ensure that the air on the second bypass flow path 30 side is discharged toward the roof-side air discharge port 10c, thereby allowing the low-temperature air passing through the cooling heat exchanger 12 to be discharged toward the upper section of the passenger room as much as possible.

Referring again to FIG. 1, the air conditioning system of the present invention includes the heating heat exchanger 14, and the heating heat exchanger 14 has a structure capable of generating heat at different temperatures for each region.

To this end, the heating heat exchanger 14 has a plurality of independently temperature-controllable heating parts 14a and 14b.

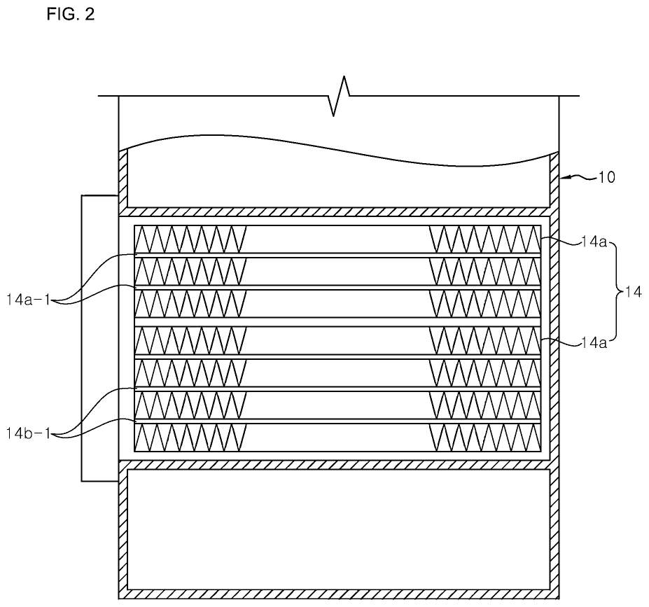

As shown in FIG. 2, each of the plurality of heating parts 14a and 14b is composed of a collection of heating rods 14a-1 and 14b-1, and is controlled independently.

Since these heating parts 14a and 14b are controlled independently, they can generate heat at different temperatures. The heating parts 14a and 14b that generate heat at different temperatures can heat the air passing through the corresponding regions in the internal flow path 10a of the air conditioning case 10 at different temperatures.

Accordingly, it is possible to heat the air passing through the internal flow path 10a of the air conditioning case 10 at different temperatures in individual regions.

Preferably, the heating parts 14a and 14b are composed of a first heating part 14a and a second heating part 14b.

As shown in FIG. 1, the first heating part 14a is preferably formed in a first region of the heating heat exchanger 14 that faces the first bypass flow path 20 in the internal flow path 10a of the air conditioning case 10 (since the first heating part and the first region are the same, they will be collectively referred to as a first heating part).

The second heating part 14b is preferably formed in a second region of the heating heat exchanger 14 that faces the cooling heat exchanger 12 in the internal flow path 10a of the air conditioning case 10 (since the second heating part and the second region are the same, they will be collectively referred to as a second heating part).

In particular, as shown in FIG. 3, the first heating part 14a is preferably installed on the air flow path extending from the first bypass flow path 20 to the floor-side air discharge port 10b.

The reason for adopting this configuration is to independently heat the air flowing from the first bypass flow path 20 toward the floor-side air discharge port 10b.

In particular, the air flowing from the first bypass flow path 20 toward the floor-side air discharge port 10b is discharged toward the lower section of the passenger room. The first heating part 14a independently heats the air discharged toward the lower section of the passenger room.

Therefore, it is possible to differentiate the temperature of the air discharged toward the lower section of the passenger room from the temperature of the air discharged toward another section of the passenger room, i.e., the upper section of the passenger room.

In particular, it is possible to make the temperature of the air discharged toward the lower section of the passenger room higher than the temperature of the air discharged toward the upper section of the passenger room.

Thus, in order to comply with the passenger's desire who feels comfortable only when a hot air is supplied to the torso and legs, the temperature of the air discharged toward the lower section of the passenger room can be made higher than the temperature of the air discharged toward the upper section of the passenger room.

As a result, by controlling only the first heating part 14a of the heating heat exchanger 14, it is possible to supply a hot air to the lower section of the passenger room, thereby improving the comfort in the passenger room.

Accordingly, since the hot air can be supplied to the lower section of the passenger room only by controlling the first heating part 14a, the electricity consumption of the heating heat exchanger 14 can be reduced without deteriorating the comfort in the passenger room.

As a result, it is possible to improve the fuel efficiency and electricity efficiency of the vehicle without deteriorating the comfort in the passenger room.

In addition, the independent control for the first heating part 14a makes it possible to differentiate the temperature of the air discharged toward the lower section of the passenger room from the temperature of the air discharged toward the upper section of the passenger room. Therefore, a relatively low temperature air can be discharged toward the upper section of the passenger room near the driver's head, and a relatively high temperature air can be discharged toward the lower section of the passenger room near the driver's torso or legs.

Accordingly, the temperature in the passenger room can be maintained in a cold-head/hot-leg state, thereby significantly improving the comfort in the passenger room.

Meanwhile, as shown in FIG. 3, the second heating part 14b is preferably configured to correspond to the air flow path extending from the cooling heat exchanger 12 to the roof-side air discharge port 10c.

This is to independently heat the air flowing from the cooling heat exchanger 12 to the roof-side air discharge port 10c.

In particular, since the air flowing from the cooling heat exchanger 12 to the roof-side air discharge port 10c is discharged to the upper section of the passenger room, the second heating part 14b is provided to independently heat the temperature of the air discharged to the upper section of the passenger room.

Accordingly, the temperature of the air discharged toward the upper section of the passenger room can be differentiated from the temperature of the air discharged toward another section, i.e., the lower section of the passenger room.

In particular, it is possible to make the temperature of the air discharged toward the upper section of the passenger room lower than the temperature of the air discharged toward the lower section of the passenger room.

Thus, in order to comply with the passenger's desire who feels comfortable only when a relatively low temperature air is supplied to the head, the temperature of the air discharged toward the upper section of the passenger room can be made lower than the temperature of the air discharged toward the lower section of the passenger room.

According to the vehicular air conditioning system of the present invention, the heating heat exchanger 14 is composed of the independently temperature-controllable first and second heating parts 14a and 14b, and the temperature of a specific section of the passenger room can be controlled to a desired temperature only by controlling the temperature of a specific one of the heating parts 14a and 14b. As a result, the electricity consumption of the heating heat exchanger 14 can be reduced without deteriorating the comfort in the passenger room.

In addition, since the electricity consumption of the heating heat exchanger 14 can be reduced without deteriorating the comfort in the passenger room, it is possible to improve the fuel efficiency and electricity efficiency of the vehicle without deteriorating the comfort in the passenger room.

In addition, since one of the first and second heating parts 14a and 14b of the heating heat exchanger 14 has a structure capable of independently controlling the temperature of the air discharged toward the lower section of passenger room, it is possible to differentiate the temperature of the air discharged toward the lower section of the passenger room from the temperature of the air discharged toward the upper section of the passenger room.

In addition, since the temperature of the air discharged toward the lower section of the passenger room can be differentiated from the temperature of the air discharged toward the upper section of the passenger room, it is possible to maintain a cold-head/hot-leg state and consequently improve the comfort in the passenger room by supplying a low-temperature air toward the upper section of the passenger room and supplying a high-temperature air toward the lower section of the passenger room.

While the preferred embodiments of the present invention have been described above, the present invention is not limited to the above-described embodiments. Various modifications and changes may be made without departing from the scope and spirit of the present invention defined in the claims.

1. A vehicular air conditioning system, comprising:
a cooling heat exchanger and a heating heat exchanger sequentially installed on an internal flow path of an air conditioning case to cool and heat an air blown from a blower;
a plurality of air discharge ports configured to discharge cold air and hot air passing through the cooling heat exchanger and the heating heat exchanger into a passenger room;
a first bypass flow path configured to allow the air blown from the blower to bypass to an upstream side of the heating heat exchanger before passing through the cooling heat exchanger; and
a first opening/closing door configured to open and close the first bypass flow path.

2. The system of claim 1, wherein the heating heat exchanger has a first region facing the first bypass flow path and a second region facing the cooling heat exchanger, and
the first region and the second region are independently temperature-controllable regions configured to generate heat at different temperatures.

3. The system of claim 2, wherein the passenger room has a section into which the air passing through the first region of the heating heat exchanger is discharged and a section into which the air passing through the second region of the heating heat exchanger is discharged, and
the temperatures of the sections of the passenger room are differentiated from each other by the air passing through the first region and the second region and having different temperatures.

4. The system of claim 2, wherein the first bypass flow path is arranged on the same air flow path as a floor-side air discharge port which constitutes the air discharge ports of the air conditioning case and discharges air toward a lower section of the passenger room, so that the air can be discharged toward the lower section of the passenger room after passing through the first region of the heating heat exchanger.

5. The system of claim 4, wherein the first region corresponds to an air flow path extending from the first bypass flow path to the floor-side air discharge port, the second region corresponds to another air flow path, and the first region is independently temperature-controllable with respect to the second region so as to independently control the temperature of the air discharged from the first bypass flow path toward the lower section of the passenger room through the floor-side air discharge port.

6. The system of claim 5, wherein the second region corresponds to an air flow path extending from the cooling heat exchanger to a roof-side air discharge port that discharges air toward an upper section of the passenger room, and the second region is independently temperature-controllable with respect to the first region so as to differentiate the temperature of the air discharged toward the lower section of the passenger room from the temperature of the air discharged toward the upper section of the passenger room.

7. The system of claim 6, wherein the first region is controlled to have a higher temperature than the first region so as to make the temperature of the air discharged toward the lower section of the passenger room higher than the temperature of the air discharged toward the upper section of the passenger room.

8. The system of claim 7, wherein the first opening/closing door is configured to open and close the first bypass flow path according to an air conditioning mode.

9. The system of claim 8, wherein in a cooling mode, the first opening/closing door is configured to block the first bypass flow path so that the air blown from the blower is cooled while passing through the cooling heat exchanger.

10. The system of claim 9, wherein in a heating mode, the first opening/closing door is configured to open the first bypass flow path so that a part of the air blown from the blower is heated while being directly introduced to the heating heat exchanger before passing through the cooling heat exchanger.

11. The system of claim 10, further comprising:
a second bypass flow path configured to allow a part of the air passing through the cooling heat exchanger to be directly bypassed to the air discharge ports before passing the heating heat exchanger; and
a second opening/closing door configured to open and close the second bypass flow path.

12. The system of claim 11, wherein the second bypass flow path is arranged on the same air flow path as a roof-side air discharge port which constitutes the air discharge ports of the air conditioning case and discharges air toward the upper section of the passenger room, so that the air on the side of the cooling heat exchanger can be directly discharged toward the upper section of the passenger room.

13. The system of claim 12, wherein the second opening/closing door is configured to open and close the second bypass flow path according to the air conditioning mode.

14. The system of claim 13, wherein in the cooling mode, the second opening/closing door is configured to open the second bypass flow path so that a part of the air passing through the cooling heat exchanger is bypassed to the air discharge ports before passing through the heating heat exchanger.

15. The system of claim 14, wherein in the heating mode, the second opening/closing door is configured to block the second bypass flow path so that the air blown from the blower is heated while passing through the heating heat exchanger.

16. The system of claim 1, which is a temperature doorless air conditioning system configured to variably control the temperature of an air discharged into the passenger room using only the heating heat exchanger without having to use a temperature door.
